(19) United States
(12) Patent Application Publication
(10) Pub. No.: US 2023/0025416 A1
(43) Pub. Date: Jan. 26, 2023

(54) Robotic Sport Games

(71) Applicants: Abraham Souder, Colorado Springs, CO (US); Natalia A. Goncharova-Souder, Colorado Springs, CO (US); John Steven Souder, Colorado Springs, CO (US)

(72) Inventors: Abraham Souder, Colorado Springs, CO (US); Natalia A. Goncharova-Souder, Colorado Springs, CO (US); John Steven Souder, Colorado Springs, CO (US)

(21) Appl. No.: 17/565,330

(22) Filed: Mar. 14, 2022

Related U.S. Application Data
(60) Provisional application No. 63/259,262, filed on Jul. 6, 2021.

(51) Int. Cl. A63F 9/24

(52) U.S. Cl. CPC A63F 9/24; A63F 2009/2483

(57) ABSTRACT

The Robotic/Electronic/Computer programmed sport games are an all sports 3-D portable game that sits on a table and is looked down upon as if looking into a stadium and can be played by two or more players. This game has all the well known sports programmed into the game and is controlled by touch screen, controller or by voice command. The game is selected at the beginning and has all the effects as if being at a live game.

1) A Robotic/Electronic/Computer Programmed Sport Games, to include but not limited to all, real-life sport games comprising of action figures replicating the actions of all games; all players will be on the court, field, ice rink, depending on the type of the sport; the game will be programmed before it starts, each player and a participant, a player, a coach, an audience or any other programmed personnel involved, will be programmed what to do according to the program set up before the game; it is not about moving the players with the remote control, but the players move and the game goes on with the electronic/computer programming; the players move totally independently according to how they were programmed before the game; the game controlled by electronic, computer or voice command; the game goes on and the plays will be changed according to the desire of person (a human) in charge; she or he may change the play in any given moment; the players as well as the field, court or the ice rink may be completely different sizes, starting with the smallest and finishing with the biggest; people will be able to put the small or smallest game set, that includes the players as well as the court, field or the ice rink of a relative size, on the top of their computer, desk or any other small surface and enjoy a live performance of the actual robotic players; same will be able to be done in the back yard or the park with the larger or the largest set of the players, field, court and an ice rink; all the components of the games will be made out of durable light weight material, easily replaceable parts and batteries, packed in an, easy carried case with extra parts; all the players, audience, referees, coaches and other people related figures will include, if necessary, magnetic pieces for stability during the play.

2) A Robotic/Electronic/Computer Sport Game machine is comprising of a cube/square box that operates under a computer programmed system which also has different types of sports, stadiums, teams, players, referees, fans, announcers etc; the sports football, basketball, golf, cricket, tennis, table tennis, volleyball, badminton, hockey, baseball, and soccer; here will be different types of stadiums for different types of sports; the cube also has a screen on both sides of it, good for two or more people to play together, without looking at each other's plays; if two or more people want to play sport, one of them presses a button that says said sport, and the cube/square box transforms into stadium to face the opposite team; once the teams have been selected, there are tunnels that players and coaches come out of; when the announcers call them out, the team takes the court, field or ice; a referee would come out with team captains and chooses which team is on offense first; they also have the ability to call penalties; When game time is on, the screens give an opinion of plays for the guys to choose; or if they wanted to play college football, those same screens would say “College,” and once one of game player presses the chosen button, the format changes. Same procedures apply here, but one of college rules; this type of example goes for the other sports, with their rules, how they start the game ect; the floor or field is magnetic, so it is easy to operate the players.

1. A Robotic/Electronic/Computer Programmed Sport Games, to include hut not limited to all, real-life sport games comprising of action figures replicating the actions of all games; all players will be on the court, field, ice rink, depending on the type of the sport; the game will be programmed before it starts, each player and a participant, a player, a coach, an audience or any other programmed personnel involved, will be programmed what to do according to the program set up before the game; it is not about moving the players with the remote control, but the players move and the game goes on with the electronic/computer programming; the players move totally independently according to how they were programmed before the game; the game controlled by electronic, computer or voice command; the game goes on and the plays will be changed according to the desire of person (a human) in charge; she or he may change the play in any given moment; the players as well as the field, court or the ice rink may be completely different sizes, starting with the smallest and finishing with the biggest; people will be able to put the small or smallest game set, that includes the players as well as the court, field or the ice rink of a relative size, on the top of their computer, desk or any other small surface and enjoy a live performance of the actual robotic players; same will be able to be done in the back yard or the park with the larger or the largest set of the players, field, court and an ice rink; all the components of the games will be made out of durable light weight material, easily replaceable parts and batteries, packed in an easy carried case with extra parts; all the players, audience, referees, coaches and other people related figures will include, if necessary, magnetic pieces for stability during the play.

2. A Robotic/Electronic/Computer Sport Game machine is comprising of a cube/square box that operates under a computer programmed system which also has different types of sports, stadiums, teams, players, referees, fans, announcers etc; the sports football, basketball, golf, cricket, tennis, table tennis, volleyball, badminton, hockey, baseball, and soccer; here will be different types of stadiums for different types of sports; the cube also has a screen on both sides of it, good for two or more people to play together, without looking at each other's plays; if two or more people want to play sport, one of them presses a button that says said sport, and the cube/square box transforms into stadium to face the opposite team; once the teams have been selected, there are tunnels that players and coaches come out of; when the announcers call them out, the team takes the court, field or ice; a referee would come out with team captains and chooses which team is on offense first; they also have the ability to call penalties; When game time is on, the screens give an opinion of plays for the guys to choose; or if they wanted to play college football, those same screens would say “College,” and once one of game player presses the chosen button, the format changes. Same procedures apply here, but one of college rules; this type of example goes for the other sports, with their rules, how they start the game ect; the floor or field is magnetic, so it is easy to operate the players.
